(19) United States
(12) Patent Application Publication
(10) Pub. No.: US 2026/0322932 A1
(43) Pub. Date: Oct. 15, 2026

(54) INFORMATION PROCESSING APPARATUS, CONTROL METHOD AND STORAGE MEDIUM

(71) Applicant: CANON KABUSHIKI KAISHA, Tokyo (JP)

(72) Inventor: YUKIHIRO NARITA, Tokyo (JP)

(21) Appl. No.: 19/633,567

(22) Filed: Mar. 30, 2026

(30) Foreign Application Priority Data
Apr. 9, 2025 (JP) 2025-064132

(51) Int. Cl. H04N 1/00; G06F 3/12

(52) U.S. Cl. CPC H04N 1/00724; G06F 3/1205; G06F 3/1228

(57) ABSTRACT

A non-transitory computer-readable storage medium stores an application program which causes an information processing apparatus to perform a control method and cooperates with a standard driver provided by a provider of an operating system of the information processing apparatus, and the control method includes acquiring detailed paper information at least including information indicating a property of paper used by a printing apparatus, and displaying paper type information indicating a type of the paper and the detailed paper information.

### BACKGROUND

### Field of the Technology

The present disclosure relates to an information processing apparatus, a control method, and a storage medium.

### Description of the Related Art

There is a known configuration in which a printer driver installed in a host computer as software for controlling a printing apparatus is used to issue a printing instruction to the printing apparatus connected to the host computer. In the host computer, an operating system (OS), which is basic software, is installed, and the printer driver is configured based on a specification predefined by the OS and is invoked by the OS to perform an operation. A vendor providing the printing apparatus provides a printer driver compliant with the specification predefined by the OS, thereby providing a unit configured to instruct the printing apparatus to print using the OS.

In recent years, Windows® provides a standard class driver (hereinafter, also referred to as the “standard driver”) that can be commonly used by printing apparatuses provided by a plurality of vendors. Such a standard driver is included in an OS package and becomes readily available for use by simply connecting a printing apparatus to the host computer. This makes it unnecessary to install a model-specific printer driver suitable for the printing apparatus, thereby enhancing usability.

Further, the standard driver is configured so that a printing function can be selected based on PrintCapabilities generated based on information acquired from the connected printing apparatus. Consequently, a user using the standard driver can select a printing function based on a capability of the connected printing apparatus although the user is using the single standard driver.

The standard driver may be associated with a function extension application (hereinafter, also referred to as the “extension application”). The extension application may be provided by the vendor providing the printing apparatus. The extension application can provide a function (extended function) that cannot be realized by the standard driver alone, by editing Print Device Capabilities (PDC) generated by the standard driver.

Japanese Patent Application Laid-Open No. 2020-9055 describes a technique for providing a print setting screen configured to receive a layout printing (N-in-1 or N-up function) setting from a user by using an extension application.

However, even in a case where the extension application as in Japanese Patent Application Laid-Open No. 2020-9055 is used, a restriction remains on a function provided.

For example, the vendor providing the printing apparatus provides vendor-specific paper and provides a function of displaying a list of detailed information about the paper in the model-specific printer driver suitable for the printing apparatus.

### SUMMARY

According to embodiments of the present disclosure, a non-transitory computer-readable storage medium stores an application program which causes an information processing apparatus to perform a control method and cooperates with a standard driver provided by a provider of an operating system of the information processing apparatus, and the control method includes acquiring detailed paper information at least including information indicating a property of paper used by a printing apparatus, and displaying paper type information indicating a type of the paper and the detailed paper information.

Features of the present disclosure will become apparent from the following description of embodiments with reference to the attached drawings. The following description of embodiments is described by way of example.

### BRIEF DESCRIPTION OF THE DRAWINGS

FIG. 1 is a block diagram illustrating a hardware configuration of a printing system.

FIGS. 2A and 2B are diagrams illustrating configurations of a printing system according to a first embodiment.

FIG. 3 is a flowchart in which detailed paper information is added to printing function information (Print Device Capabilities (PDC)).

FIG. 4A illustrates an example of capability information including attribute information returned by a printing apparatus using a media-col-database.

FIGS. 4B1 and 4B2 illustrate an example of capability information including attribute information returned by a printing apparatus using a media-col-database.

FIGS. 4C1 and 4C2 illustrate an example of capability information including attribute information returned by a printing apparatus using a media-col-database.

FIG. 5A illustrates an example of a print setting screen displayed by a print setting screen extension unit.

FIG. 5B illustrates an example of a paper type setting screen displayed by the print setting screen extension unit.

FIG. 5C illustrates an example of a paper type setting screen displayed by the print setting screen extension unit.

FIG. 5D illustrates an example of a print setting screen displayed by a print setting screen extension unit.

FIG. 5E illustrates an example of a print setting screen displayed by a print setting screen extension unit.

FIG. 6 illustrates an example of a paper information list including paper type information displayed on the paper type setting screen.

FIG. 7 illustrates an example of a PrintTicket in which paper size and paper type are selected as paper information.

FIG. 8 is a flowchart in which detailed paper information not defined by an operating system (OS) is acquired from an extension application.

FIG. 9 is a diagram illustrating a configuration of a printing system according to a third embodiment.

### DESCRIPTION OF THE EMBODIMENTS

Hereinafter, embodiments of the present disclosure will be described in detail with reference to the accompanying drawings. It should be noted that the following embodiments do not limit the present disclosure as defined in the claims, and not all combinations of the features described in the embodiments are necessarily essential as solutions of the present disclosure.

In addition, identical components are denoted by identical reference numerals, and detailed descriptions thereof will be omitted.

### FIRST EMBODIMENT

### Hardware Configuration of a Printing System

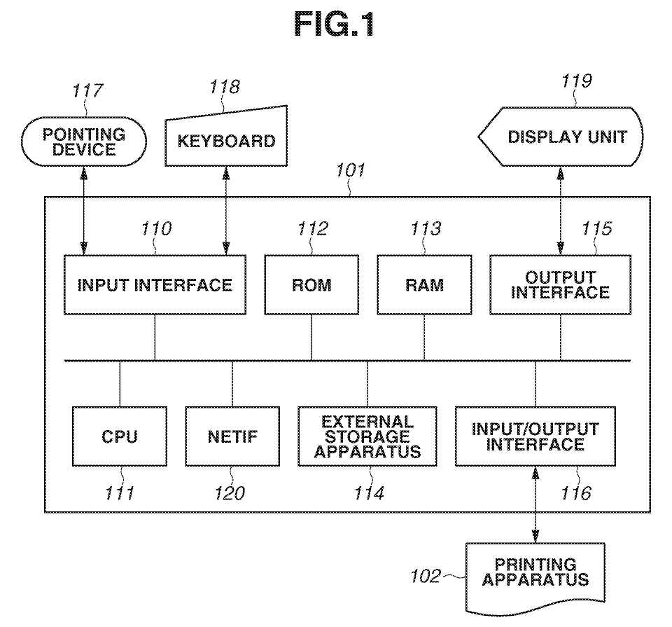

FIG. 1 is a block diagram illustrating a hardware configuration of a printing system. In FIG. 1, a host computer 101 is an example of an information processing apparatus and includes an input interface 110, a central processing unit (CPU) 111, a read-only memory (ROM) 112, a random access memory (RAM) 113, an external storage apparatus 114, an output interface 115, and an input/output interface 116.

Further, input devices, such as a keyboard 118 and a pointing device 117, are connected to the input interface 110, and a display device, such as a display unit 119, is connected to the output interface 115.

A network interface (NETIF) 120 performs control for data transfer with an external device via a network.

The ROM 112 stores an initialization program. The external storage apparatus 114 stores application programs, an operating system (OS), print data generation software, and various other types of data. The RAM 113 is used as a work memory or the like during execution of various programs stored in the external storage apparatus 114 and enables the various programs to run on the host computer 101.

In the present embodiment, the CPU 111 performs a process in accordance with instructions of a program stored in the ROM 112, thereby performing a function of the host computer 101, which will be described below, and a process illustrated in a flowchart, which will be described below. A printing apparatus 102, which is a device, is connected to the host computer 101 via the input/output interface 116 to communicate with the host computer 101.

While the host computer 101 and the printing apparatus 102 are configured separately herein, the host computer 101 and the printing apparatus 102 may be configured as a single information processing apparatus. While an ink-jet printer configured to print by discharging ink onto a paper surface is described as an example of the printing apparatus 102, other methods (such as an electrophotographic method) may be employed to perform printing. Further, the host computer 101 may be a desktop personal computer, a smartphone, or a laptop personal computer.

### Software-Centric Configuration of the Printing System

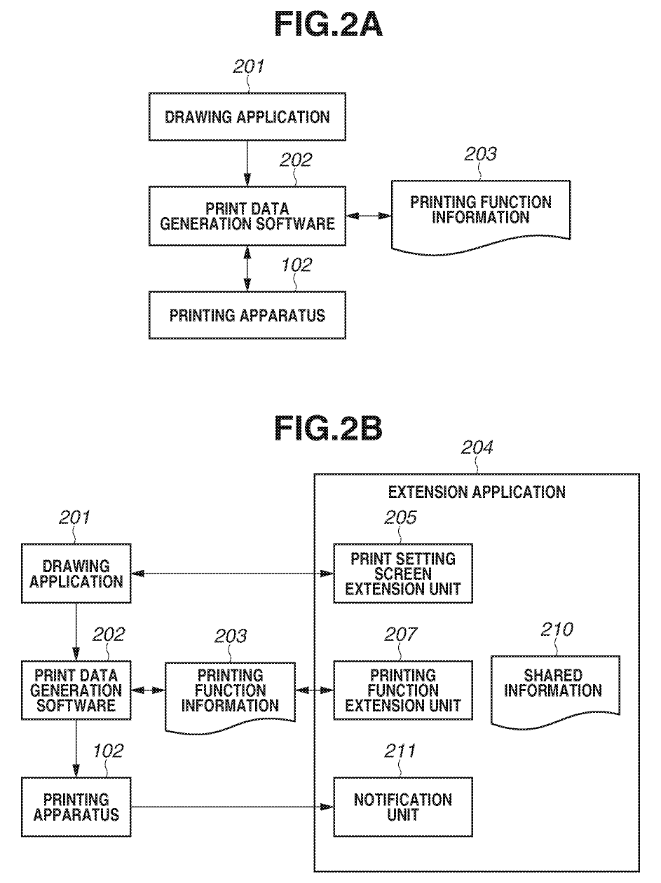

FIGS. 2A and 2B are schematic diagrams illustrating software-centric configurations of the printing system. The following description is based on a printing system using the host computer 101 running Microsoft® Windows® as the operating system. FIG. 2A is a diagram illustrating a general configuration in which an extension application 204 is not associated with either print data generation software 202 or the printing apparatus 102.

Further, in the present specification, a printing module (which may include the print data generation software 202) of the OS may be referred to as printing software. In the present embodiment, a process performed by the information processing apparatus based on an instruction from the print data generation software 202 may be performed based on an instruction from the printing software or the OS. Similarly, an operation performed on the print data generation software 202 by the extension application 204 may be performed on the printing software or the OS.

A drawing application 201 is software configured to create content (drawing data) to be printed. Examples include a word processing application and a spreadsheet application. Upon receiving a printing request from a user, the drawing application 201 issues a printing instruction to the OS. The printing instruction includes print setting information for specifying the operation of the print data generation software 202 and the printing apparatus 102. The print setting information is also referred to as a PrintTicket (hereinafter, also referred to as “PT”).

The drawing application 201 is configured to display a print setting screen provided by the print data generation software 202, the OS, or the drawing application 201 to output the print setting information. The print setting screen includes an object (hereinafter, also referred to as “control item”) specifying a settable printing function and a control item specifying a setting value for the object, based on capability information (information settable as a print setting) acquired from the print data generation software 202. The capability information is also referred to as PrintCapabilities (hereinafter, also referred to as “PC”).

The print data generation software 202 determines the PC based on printing function information 203. The printing function information 203 is printing function data describing all settable printing functions, setting values thereof, and exclusion relations among the setting values. The printing function information 203 is also referred to as Print Device Capabilities (PDC).

The PDC 203 is included in a configuration file of the print data generation software 202 and stored in the external storage apparatus 114 as an immutable file. Alternatively, the print data generation software 202 may dynamically generate the PDC 203. In this case, the generated PDC 203 is editable. Specifically, the print data generation software 202 or the OS may be configured to acquire attribute data of the printing apparatus 102 from the printing apparatus 102 and generate the PDC 203 based on attribute information included in the acquired attribute data.

The attribute data of the printing apparatus 102 is acquired by issuing an Internet Print Protocol (IPP) Get-Printer-Attributes operation to the printing apparatus 102. A response to the Get-Printer-Attributes includes the attribute information indicating a function (capability of the printing apparatus 102) selectable for the printing apparatus 102 and a setting value relating to the attribute information. The response is saved in the RAM 113.

The foregoing configuration enables the print data generation software 202 to configure an available printing function of the connected printing apparatus 102 so that the user can select the printing function. Specifically, even in a case where the printing apparatus 102 having a different function or the printing apparatus 102 developed by a different vendor is connected, the print data generation software 202 can configure an available printing function of the connected printing apparatus 102 so that the user can select the printing function.

In the present specification, a configuration in which an IPP class driver built into Windows® is employed as the print data generation software 202 is described.

The IPP class driver is a printer driver configured to perform a printing process based on a specification of a standard printing protocol referred to as the IPP, and is included in the OS package.

The IPP class driver and a Universal Print (UP) class driver are not printer drivers specific to a model of the printing apparatus 102 but standard class drivers configured to transmit print data to a plurality of different printing apparatuses 102 provided by a plurality of different manufacturers. The IPP class driver is a standard driver configured to perform local printing based on the specification. Further, a configuration using the Universal Print class driver, which is a standard driver configured to perform cloud printing based on the specification, may be employed.

In a case where cloud printing is performed using the UP class driver, print data is transmitted to the printing apparatus 102 via a service relating to cloud printing, instead of being transmitted directly to the printing apparatus 102, and the printing apparatus 102 performs printing. Further, the IPP class driver and the UP class driver acquire attribute information from the connected printing apparatus 102 and generate the printing function information 203 based on the acquired information so that the user can select a printing function supported by the connected printing apparatus 102.

The OS generates intermediate data (input data) based on a printing instruction output from the drawing application 201 and passes the intermediate data to the print data generation software 202. Data output for printing by the drawing application 201 is data in Graphic Device Interface (GDI) format (data in GDI format) or data in Extensible Markup Language (XML) Paper Specification format (data in XPS format).

In a case where the print data generation software 202 is used, if the data output by the drawing application 201 is data in GDI format, the OS converts the data in GDI format output by the drawing application 201 into data in XPS format. Then, the converted data in XPS format is passed to the print data generation software 202 as the intermediate data. If the data output by the drawing application 201 is data in XPS format, the OS passes the data in XPS format to the print data generation software 202 as the intermediate data.

The intermediate data includes drawing data and print setting information set by the user. The drawing data is information representing an image to be formed on a paper surface.

The print data generation software 202 converts the acquired intermediate data into print data interpretable by the printing apparatus 102 and transmits the print data to the printing apparatus 102. The print data includes the drawing data, which is information representing an image to be formed on a paper surface, and print setting attribute information (attribute information specifying a print setting) generated based on the print setting information set by the user. The print setting attribute information includes attribute information specifying a function (capability of the printing apparatus 102) specifiable on the printing apparatus 102 and a setting value relating to the attribute information.

The printing apparatus 102 performs printing on a paper surface based on the print data transmitted from the print data generation software 202. At this time, the printing apparatus 102 forms the drawing data included in the print data on the paper surface by performing an operation based on the print setting attribute information included in the print data. The print setting attribute information includes attribute information for specifying print quality (such as image quality priority and speed priority), duplex printing, and the like and a setting value for the attribute information. For example, in a case where the print setting attribute information includes attribute information specifying duplex printing, the printing apparatus 102 performs duplex printing.

FIG. 2B is a diagram illustrating a configuration in which the extension application 204 is associated with the print data generation software 202 and the printing apparatus 102. Any configuration or process not specifically described in the following description is similar to the corresponding configuration or process illustrated in FIG. 2A.

The extension application 204 is software configured to extend the function of the print data generation software 202 and is not included in advance in the OS (not included in the same package). Thus, the user is required to operate the host computer 101 to download the extension application 204 from a server, which is an external apparatus, via the Internet and install the extension application 204. The extension application 204 is an example of an application program configured to cooperate with printing software including the IPP class driver.

Alternatively, the extension application 204 may be installed automatically in a case where the printing apparatus 102 is connected to the host computer 101. Specifically, in a case where the printing apparatus 102 is connected to the host computer 101, the OS acquires device identification information from the printing apparatus 102. The OS may download the extension application 204 corresponding to the acquired device identification information from the server via the Internet and install the extension application 204. Specifically, the print data generation software 202 and the extension application 204 are stored as separate files on the host computer 101.

The print data generation software 202 and the extension application 204 may be updated to a newer version, and the updating processes are performed at separate times. In other words, the timing at which the print data generation software 202 is acquired by the host computer 101 differs from the timing at which the extension application 204 is acquired by the host computer 101. Further, the trigger that causes the host computer 101 to acquire the print data generation software 202 differs from the trigger that causes the host computer 101 to acquire the extension application 204.

In a case where the extension application 204 is installed, the OS associates the extension application 204 with the print data generation software 202 and the printing apparatus 102.

The extension application 204 described in the present embodiment includes a print setting screen extension unit 205, a printing function extension unit 207, and a notification unit 211. Further, the extension application 204 includes shared information 210 commonly accessible by each unit. The actual form of the shared information 210 is a file stored in the external storage apparatus 114 or information stored in the RAM 113.

The extension application 204 can freely write or read information to or from the shared information 210 by using an application program interface (API) provided by the OS. Further, the shared information 210 is allocated as an area for application-specific information storage and may store information other than the attribute data of the printing apparatus 102.

The shared information 210 is information different from the PDC 203 generated by the print data generation software 202 or the OS to specify an available printing function of the connected printing apparatus 102.

The operation of the extension application 204 may be terminated each time processing by a unit is completed. In this case, the OS activates the extension application 204 each time a request to use a unit is received. Further, other forms are also possible. For example, the OS may terminate the operation of the extension application 204 upon completion of processing by the print setting screen extension unit 205, and the OS may keep the extension application 204 running even after completion of processing by the printing function extension unit 207.

Furthermore, while a unit performs processing, the extension application 204 may cancel the processing. In a case where the processing is canceled, a job being processed in a print queue is deleted by the OS.

Upon receiving a printing request from the user, the drawing application 201 issues a printing instruction to the OS. Even in this configuration, as in the configuration illustrated in FIG. 2A, the drawing application 201 is capable of displaying a print setting screen. In this configuration, a print setting screen provided by the extension application 204 is displayed. Specifically, a print setting screen provided by the print setting screen extension unit 205 of the extension application 204 is displayed.

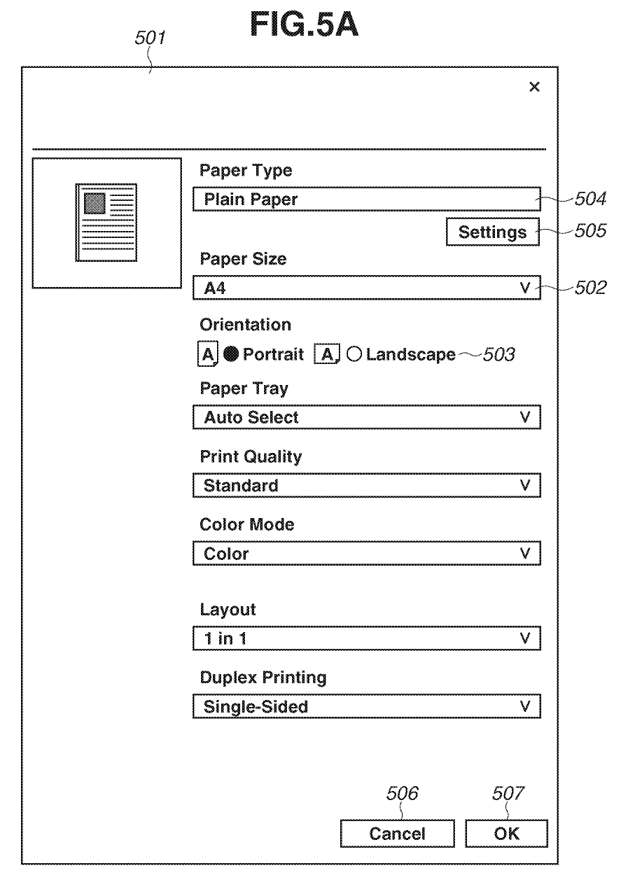

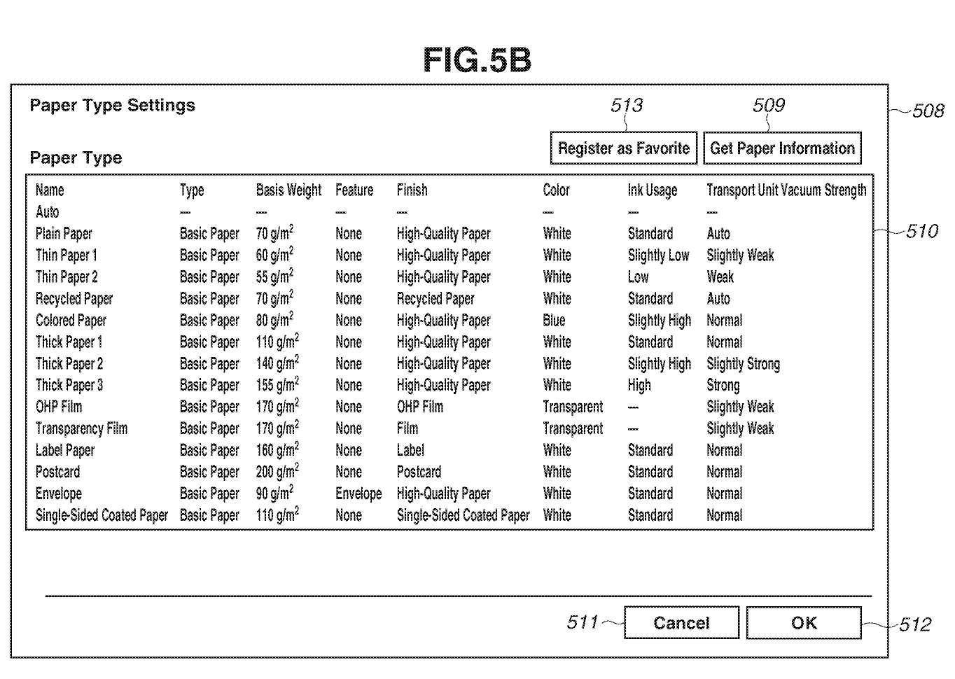

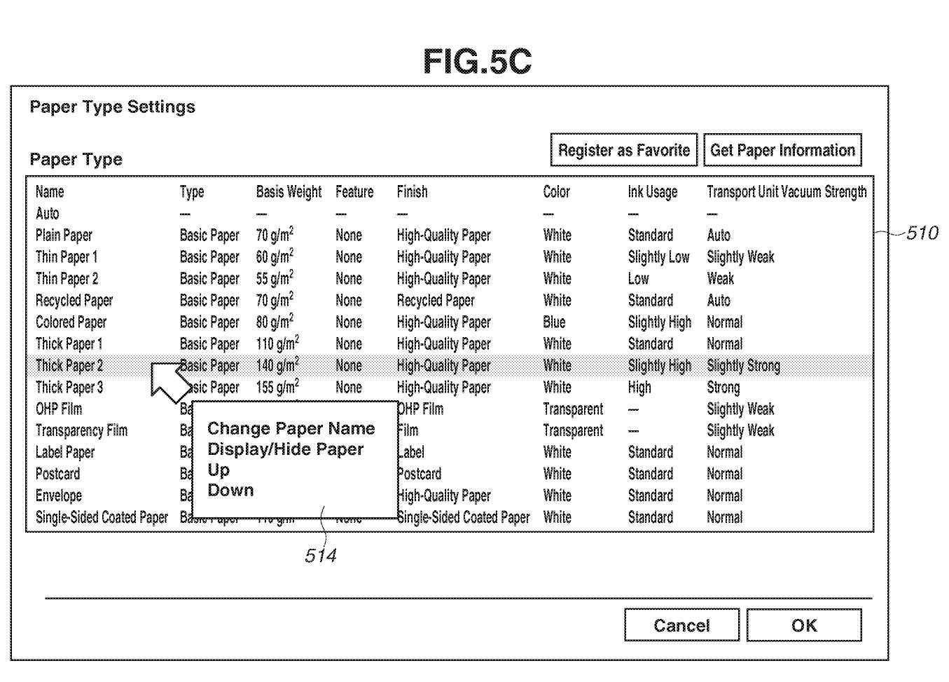

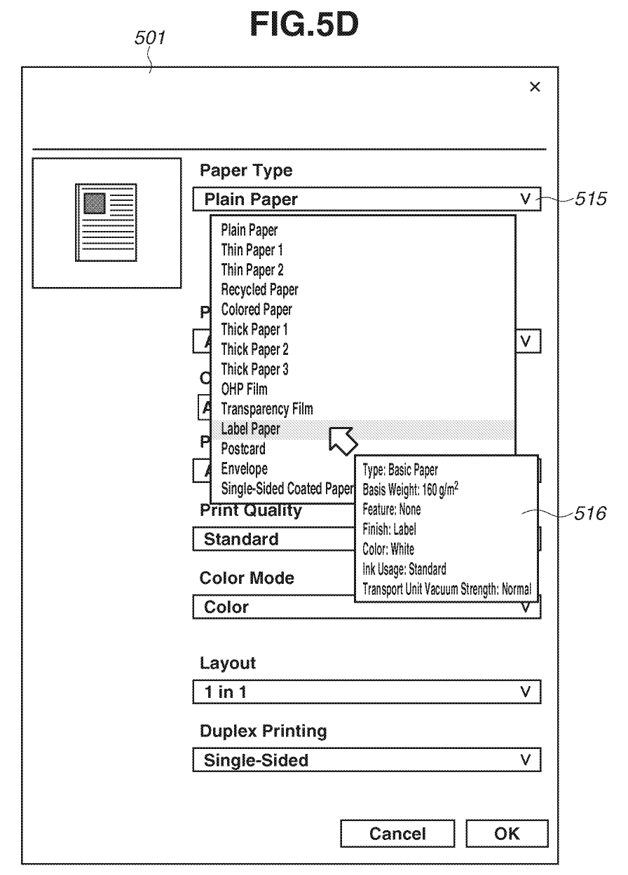

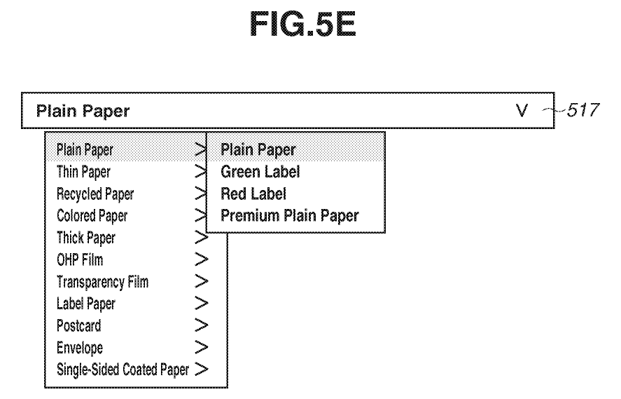

Whether the print setting screen provided by the print setting screen extension unit 205 is displayed depends on a user operation. For example, in a case where the drawing application 201 is a word processing application or a spreadsheet application, when the user presses a property setting button displayed on a print setting screen provided by the word processing application or the spreadsheet application, the print setting screen provided by the print setting screen extension unit 205 is displayed. Details of the print setting screen extension unit 205 will be described below with reference to FIGS. 5A-5E.

Further, in a case where the drawing application 201 receives a printing request from the user and issues a printing instruction to the OS, the OS generates intermediate data based on the printing instruction output from the drawing application 201 and passes the intermediate data to the print data generation software 202.

The print data generation software 202 processes the intermediate data into print data interpretable by the printing apparatus 102 and passes the print data to the printing apparatus 102 via the OS. The printing apparatus 102 performs printing on a paper surface based on the received print data. A function provided by the OS may be used to convert the intermediate data into the print data.

Further, the extension application 204 includes the printing function extension unit 207. The printing function extension unit 207 is configured to edit the PDC 203 generated by the print data generation software 202 or the OS. This enables the printing function extension unit 207 to add a function provided by the extension application 204, a function supported by the printing apparatus 102 but not supported by the print data generation software 202, or the like. Further, an exclusion relation between setting values for the printing function or the like may be added.

The OS activates the printing function extension unit 207 upon initial association of the printing apparatus 102 with the print data generation software 202 by the extension application 204. Furthermore, the OS may activate the printing function extension unit 207 at other times, such as upon OS activation. This enables the printing function extension unit 207 to detect an extended function and add the extended function to the PDC 203 in a case where a new paper type is added to the printing apparatus 102 afterward and a function relating to printing is extended.

Further, the extension application 204 includes the notification unit 211. The notification unit 211 is configured to display a notification to the user in response to an error occurring in the printing apparatus 102.

For example, in a case where a paper empty error occurs in the printing apparatus 102, the print data generation software 202 detects the paper empty error, and the OS displays a message on the display unit 119 using a notification function referred to as a toast notification, which is a function of the OS. Upon the user pressing the toast notification, the notification unit 211 of the extension application 204 is invoked by the OS, and a user interface screen of the notification unit 211 is displayed. For example, the user interface screen of the notification unit 211 is configured to display a detailed message indicating the paper empty error, a paper loading method, and the like.

Once print data is transmitted to the printing apparatus 102, the extension application 204 can no longer display a screen, such as a guide associated with the print data, during processing by a unit.

Further, the configuration of the extension application 204 configured to realize the present embodiment is not limited to a configuration including all the functions (units) described above, and a configuration including only some of the functions or a configuration including another function may be employed. Further, the extension application 204 may be referred to simply as printing software. As described above, the extension application 204 includes at least one of the units 205, 207, and 211.

### Addition of Detailed Paper Information to Printing Function Information by the Printing Function Extension Unit

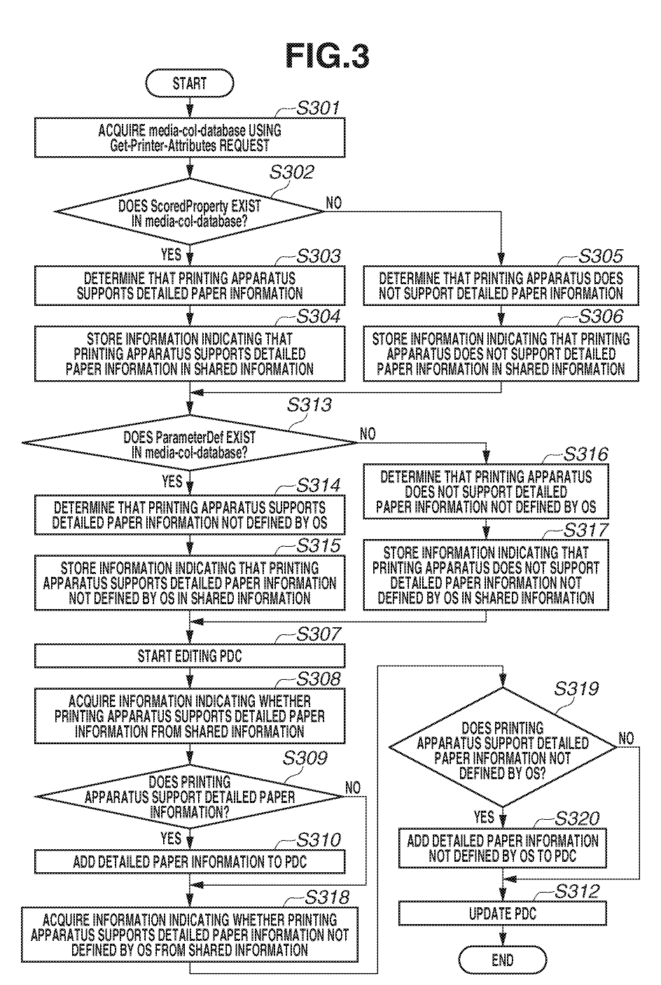

A process in which the printing function extension unit 207 of the extension application 204 adds detailed paper information to the printing function information 203 will be described with reference to FIG. 3.

The process illustrated in FIG. 3 is started in a case where a print queue associated with the extension application 204 is selected by the user and the print setting screen extension unit 205 of the extension application 204 is activated. Alternatively, the OS may activate the extension application 204 directly without requiring the user to manually activate the extension application 204.

In step S301, the printing function extension unit 207 of the extension application 204 acquires attribute information from the printing apparatus 102. The attribute information is acquired as a response from the printing apparatus 102 to an IPP Get-Printer-Attributes operation issued to the printing apparatus 102 by the printing function extension unit 207. Step S301 is an example of an acquiring step.

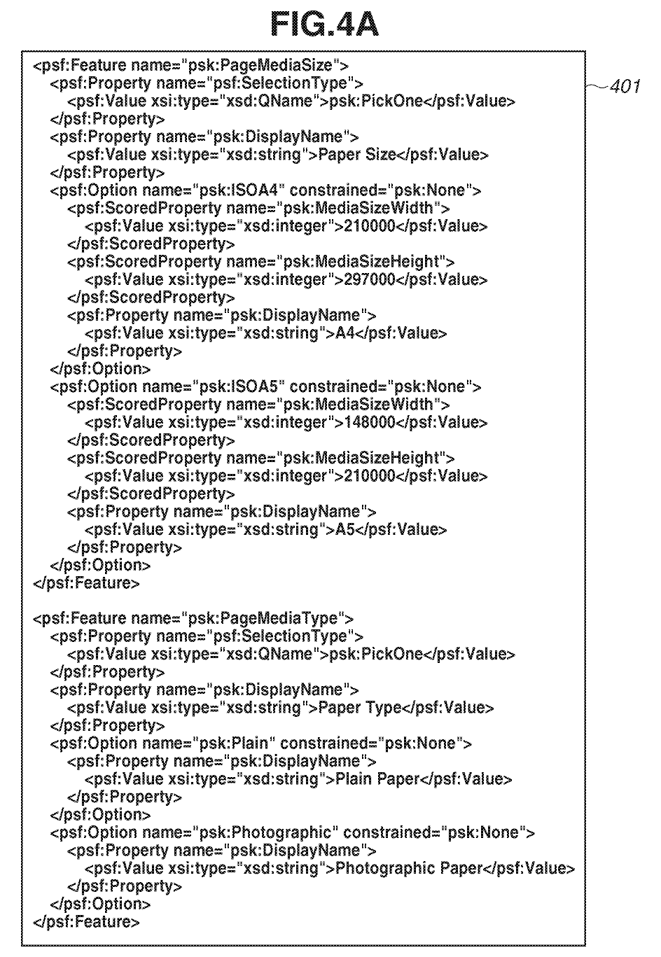

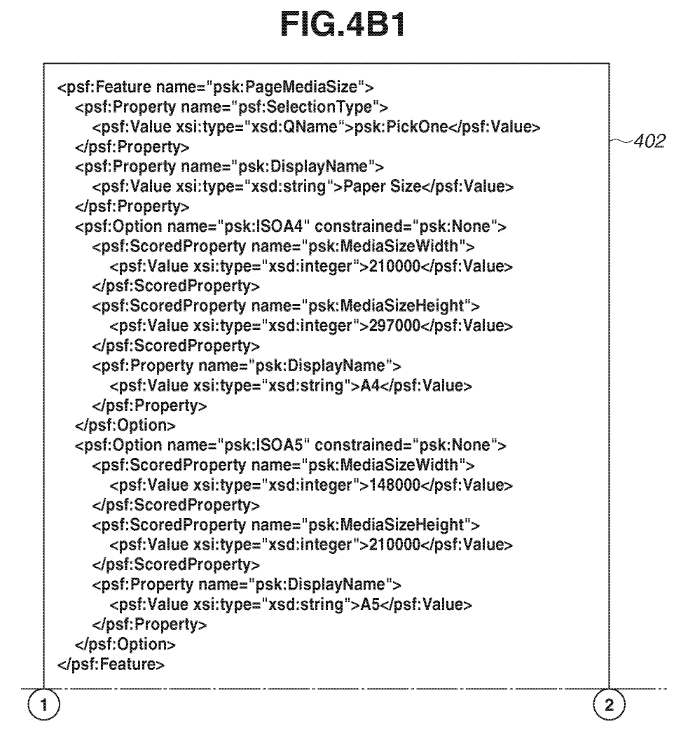

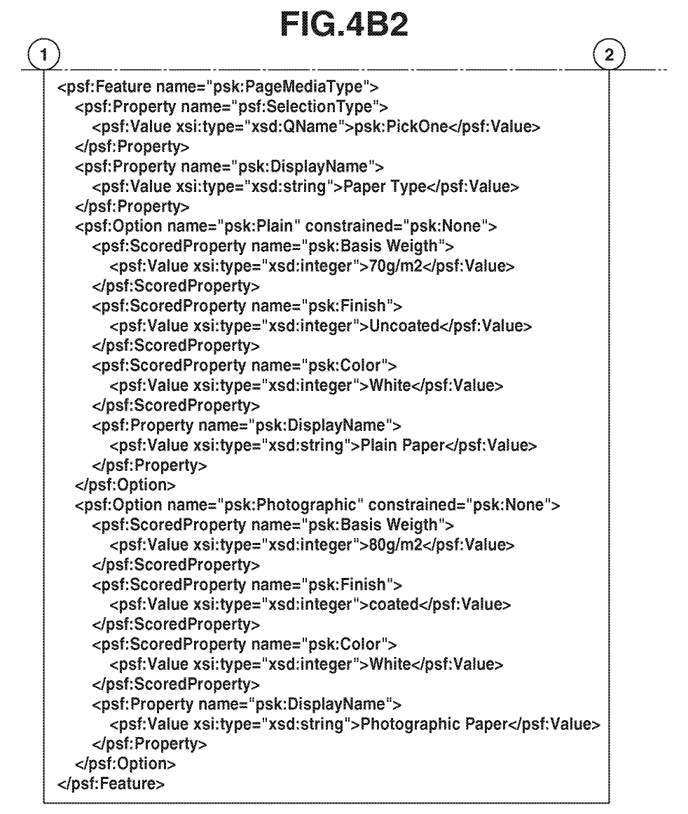

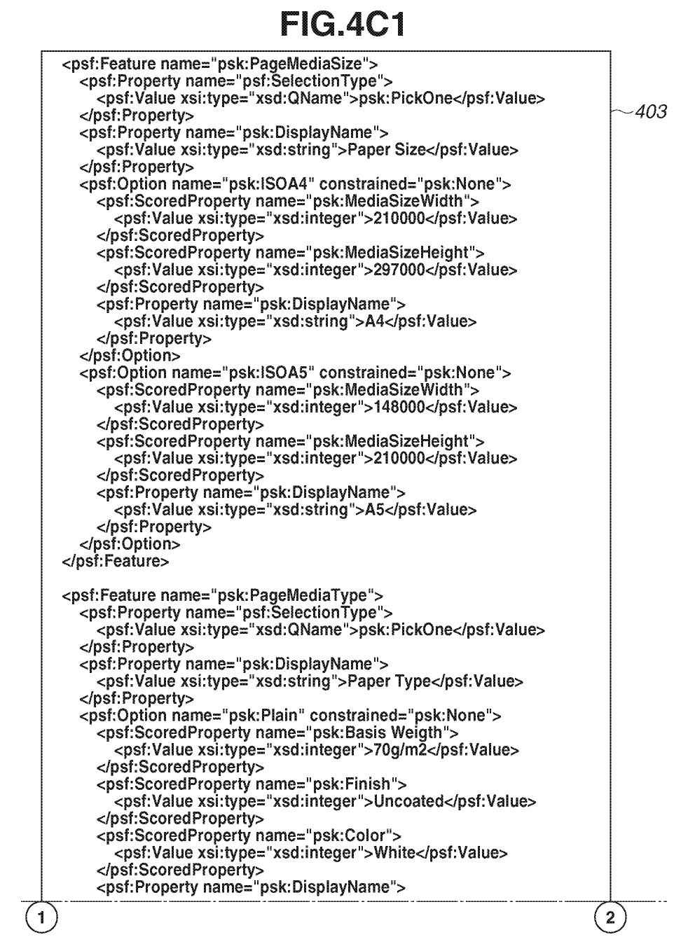

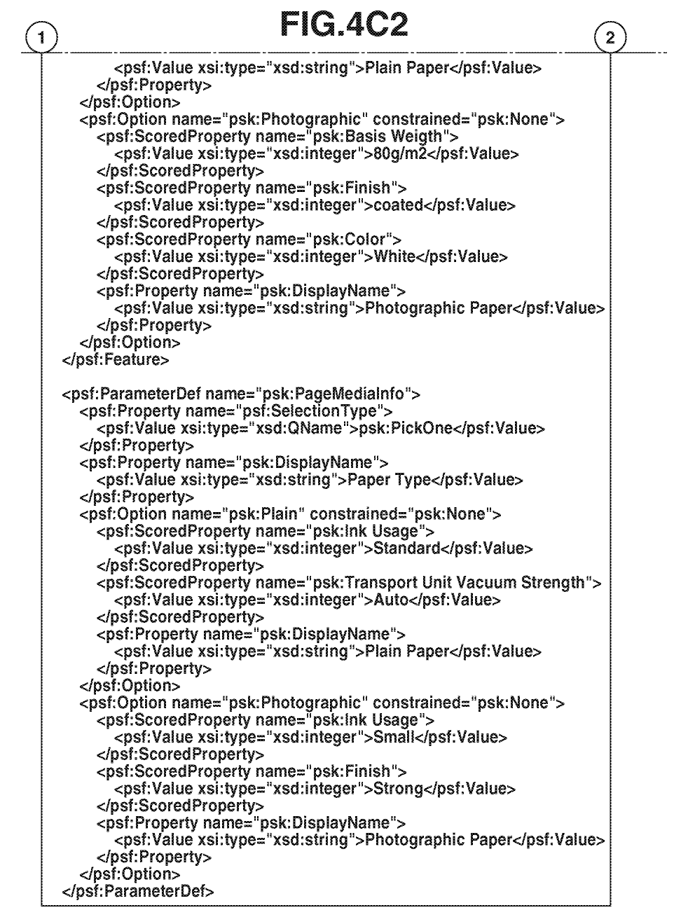

While there is a plurality of types of attribute information that can be acquired as a response from the printing apparatus 102, a media-col-database attribute value is acquired in the present embodiment. The media-col-database attribute value describes detailed information about a paper setting printable by the printing apparatus 102. An example of capability information including information returned by the printing apparatus 102 using the media-col-database attribute will be described with reference to FIGS. 4A-4C2.

Capability information 401 illustrated in FIG. 4A describes a portion of the capability information including the attribute information about printable paper information returned by the printing apparatus 102 in the media-col-database attribute in XML format based on a format defined by the OS. The printing function extension unit 207 provides a print setting screen to the print setting screen extension unit 205 based on information described in the capability information 401.

The print data generation software 202 herein includes paper size and paper type functions as paper information setting items. Specifically, the capability information 401 includes a paper size setting (corresponding to an item describing a “PageMediaSize” in a “Feature”) and a paper type setting (corresponding to an item describing a “PageMediaType” in the “Feature”).

Further, the print data generation software 202 may include A4 (“Option” describing “ISOA4”), A5 (“Option” describing “ISOA5”), and the like as options corresponding to paper size setting items. As options corresponding to paper type setting items, plain paper (“Option” describing “Plain”), photographic paper (“Option” describing “Photographic”), and the like may be included. The paper size and the paper type may include other options and may not include these options.

While the actual setting items of the paper information of the print data generation software 202 include paper information (such as a margin setting) other than the two setting items described above, for simplicity of description, the paper information other than the two setting items is omitted.

Next, capability information 402 illustrated in FIGS. 4B1 and 4B2 indicates that there is detailed information other than the paper information described in the capability information 401 in FIG. 4A. In this case, a “ScoredProperty” parameter is provided, and the detailed information is described in the ScoredProperty parameter.

Specifically, as illustrated in FIGS. 4B1 and 4B2, Basis weight, finish, and color are described in an Option as setting values corresponding to the plain paper and photographic paper items. In the Option, “Basis Weight” is described as a ScoredProperty for the basis weight, “Finish” is described as a ScoredProperty for the finish, and “Color” is described as a ScoredProperty for the color. The paper information other than the detailed paper information are described normally as in FIG. 4A.

The capability information 402 in FIGS. 4B1 and 4B2 and the capability information 403 in FIGS. 4C1 and 4C2 may include paper feature information besides the basis weight, the finish, and the color of each type of paper. In this case, for example, “Envelope” is described as a paper feature for an envelope in the detailed paper information on a paper type setting screen 508 illustrated in FIG. 5B. Furthermore, “Punched Paper” is described as a paper feature for punched paper. In a case where the capability information 402 or 403 includes the paper feature information, for example, “Sheet Type” is described as ScoredProperty in the Option.

The information indicating the basis weight, finish, color, and feature of paper is an example of paper property information. The paper property information may include information other than the information indicating the basis weight, finish, color, and feature of paper, or may include only some of the information.

Furthermore, the capability information 403 illustrated in FIGS. 4C1 and 4C2 includes attribute information about paper information not included in the capability information 401 in FIG. 4A or the capability information 402 in FIGS. 4B1 and 4B2, i.e., vendor-specific paper information not defined by the OS. In this case, a “ParameterDef” parameter is provided, and the information is described in the ParameterDef parameter. With this description, it becomes possible to list and display the information not defined by the OS as the detailed paper information as illustrated in FIG. 5B, which will be described below, using the extension application 204.

Specifically, as illustrated in FIGS. 4C1 and 4C2, a paper information (“ParameterDef” in “PageMediaInfo”) item and an option for the item are described as a ScoredProperty in the ParameterDef. For example, for ink usage in FIG. 5B, “Ink Usage” is described as a ScoredProperty in the capability information 403. Further, for a vacuum strength of a transport unit, “Transport Unit” is described as a ScoredProperty. The paper information defined by the OS is described as in FIGS. 4A, 4B1 and 4B2.

The ink usage is an example of information relating to image processing performed by the printing apparatus 102, and the information indicating the vacuum strength of the transport unit is an example of information relating to control performed by the printing apparatus 102.

In the present embodiment, the paper property information, the information relating to the image processing performed by the printing apparatus 102, and the information relating to the control performed by the printing apparatus 102 are collectively defined as the detailed paper information. The detailed paper information at least includes the paper property information. Further, the items included in the detailed paper information are not limited to the items described in the present embodiment. Information other than the items described in the present embodiment may be included, or only some of the items may be included.

Further, the detailed paper information may include information defined by the OS, information not defined by the OS, or both.

Returning to the description of FIG. 3, in step S301 in FIG. 3, the printing function extension unit 207 acquires attribute information including paper information from the printing apparatus 102, and the processing proceeds to step S302. Each of the capability information 401, 402, and 403 illustrated in FIGS. 4A, 4B1, 4B2, 4C1 and 4C2, includes the attribute information.

In step S302, the printing function extension unit 207 checks the paper information obtained from the media-col-database attribute. Specifically, it is determined whether a ScoredProperty parameter exists in a print-type setting (an item describing “PageMediaType” in “Feature”). In step S302, in a case where a ScoredProperty parameter exists, the printing function extension unit 207 determines that the processing result is YES (YES in step S302), and the processing proceeds to step S303.

In the case where a ScoredProperty parameter exists in the print-type setting in the paper information, in step S303, it is determined that the connected printing apparatus 102 supports the detailed paper information, and the processing proceeds to step S304.

In step S304, the printing function extension unit 207 stores information indicating that the connected printing apparatus 102 supports the detailed paper information in the shared information 210, and the processing proceeds to step S307.

On the other hand, in step S302, in a case where the printing function extension unit 207 determines that the processing result is NO (NO in step S302), the processing proceeds to step S305.

In the case where a ScoredProperty parameter does not exist in the print-type setting in the paper information, in step S305, it is determined that the connected printing apparatus 102 does not support the detailed paper information, and the processing proceeds to step S306.

In step S306, the printing function extension unit 207 stores information indicating that the connected printing apparatus 102 does not support the detailed paper information in the shared information 210, and the processing proceeds to step S313.

In step S313, the printing function extension unit 207 checks the paper information obtained from the media-col-database attribute and determines whether a ParameterDef parameter exists. In step S313, in a case where a ParameterDef parameter exists, the printing function extension unit 207 determines that the processing result is YES (YES in step S313), and the processing proceeds to step S314.

In the case where a ParameterDef parameter exists in the paper information, in step S314, it is determined that the connected printing apparatus 102 supports the detailed paper information not defined by the OS, and the processing proceeds to step S315.

In step S315, the printing function extension unit 207 stores information indicating that the connected printing apparatus 102 supports the detailed paper information not defined by the OS in the shared information 210, and the processing proceeds to step S307.

On the other hand, in step S313, in a case where the printing function extension unit 207 determines that the processing result is NO (NO in step S313), the processing proceeds to step S316.

In a case where a ParameterDef parameter does not exist in the paper information, in step S316, it is determined that the connected printing apparatus 102 supports only the paper information defined by the OS, and the processing proceeds to step S317.

In step S317, the printing function extension unit 207 stores information indicating that the connected printing apparatus 102 does not support the detailed paper information not defined by the OS in the shared information 210, and the processing proceeds to step S307.

In the present embodiment, the printing function extension unit 207 is configured to store the name of the connected printing apparatus 102 in association with the detailed paper information and information indicating whether the detailed paper information not defined by the OS is supported. However, the printing function extension unit 207 may store other information in the shared information 210. For example, the printing function extension unit 207 may store a list of combinations of the name of the printing apparatus 102 and the paper information acquired from the media-col-database attribute in the shared information 210.

Further, other information may be stored in association with the shared information 210. Examples include a connection method of the printing apparatus 102 and a type of the printing apparatus 102 (such as an ink-jet printer or a laser printer). Further examples include paper size and paper type information printable by the printing apparatus 102 and printing function information other than a function associated with usable paper.

After the printing function extension unit 207 stores information indicating whether the printing apparatus 102 supports the detailed paper information not defined by the OS in the shared information 210 in step S315 or S317, the processing proceeds to step S307.

In step S307, the printing function extension unit 207 acquires the PDC 203 from the print data generation software 202 or the OS and starts a PDC editing process, and the processing proceeds to step S308.

In step S308, the printing function extension unit 207 acquires information indicating whether the printing apparatus 102 supports the detailed paper information from the shared information 210. After the information is acquired from the shared information 210, the processing proceeds to step S309.

In step S309, the printing function extension unit 207 determines whether the connected printing apparatus 102 supports the detailed paper information, based on the information acquired from the shared information 210. In a case where the determination result is YES (YES in step S309), the processing proceeds to step S310.

In step S310, the printing function extension unit 207 edits the acquired PDC 203 and adds the detailed paper information to the PDC 203, and the processing proceeds to step S318.

In step S309, in a case where the printing function extension unit 207 determines that the result is NO (NO in step S309), the processing proceeds to step S318 without adding the detailed paper information to the PDC 203 in step S310.

In step S318, the printing function extension unit 207 acquires information indicating whether the printing apparatus 102 supports the detailed paper information not defined by the OS from the shared information 210. After the information is acquired from the shared information 210, the processing proceeds to step S319.

In step S319, the printing function extension unit 207 determines whether the connected printing apparatus 102 supports the detailed paper information not defined by the OS, based on the information acquired from the shared information 210. In a case where the determination result is YES (YES in step S319), the processing proceeds to step S320.

In step S320, the printing function extension unit 207 edits the acquired PDC 203 and adds the detailed paper information not defined by the OS to the PDC 203, and the processing proceeds to step S312.

In step S319, in a case where the printing function extension unit 207 determines that the result is NO (NO in step S319), the processing proceeds to step S312 without adding the detailed paper information not defined by the OS to the PDC 203 in step S320.

In step S312, the printing function extension unit 207 updates the PDC 203 based on the information edited in steps S310 and S320 and other print setting information. PC is generated based on the PDC 203 edited by the printing function extension unit 207. A print setting screen 501 illustrated in FIGS. 5A or 5D, which will be described below, is displayed based on the PC. On the print setting screen 501, the printing function and other printing functions are selected by the user, and the print setting screen extension unit 205 applies the selected printing functions to the PT.

As a result of the processing by the printing function extension unit 207 described above, the detailed paper information is made available in a case where the printing apparatus 102 supports the detailed paper information, or the detailed paper information not defined by the OS is made available in a case where the printing apparatus 102 supports the detailed paper information not defined by the OS.

Thereafter, the drawing application 201 receives a printing request from the user and issues a printing instruction to the OS. After the printing instruction is issued to the OS, intermediate data including the PT is generated based on the printing instruction output from the drawing application 201 and passed to the print data generation software 202. The print data generation software 202 processes the intermediate data into print data interpretable by the printing apparatus 102 and passes the print data to the printing apparatus 102 via the OS.

The printing apparatus 102 extracts the PT generated by the extension application 204 from the received print data and analyzes the print setting attribute information. The analyzed print setting attribute information is compared with attribute information indicating a selectable function (capability of the printing apparatus 102) stored in a database (not illustrated) included in the printing apparatus 102, and a setting value associated with the attribute information is determined. Drawing data is formed on a paper surface based on the determined setting value and printed.

### Example of a Screen Configured to Display Detailed Paper Information by the Print Setting Screen Extension Unit

Next, a print setting screen displayed by the print setting screen extension unit 205 and configured to display the detailed paper information will be described with reference to FIGS. 5A and 5B. The technique according to the present disclosure makes it possible to display the detailed paper information at least including the paper type information and the paper property information even in a case where an application supporting the standard driver is used.

PC is generated based on the PDC 203 edited by the printing function extension unit 207. In the present embodiment, the print setting screen 501 is displayed based on the PC generated based on the PDC 203 edited and updated by the printing function extension unit 207 in FIG. 3. In steps S310 and S320 described above, the detailed paper information is added by the printing function extension unit 207. This makes it possible for the user to display the detailed paper information on the paper type setting screen 508 illustrated in FIG. 5B via the print setting screen 501 in FIG. 5A displayed by the print setting screen extension unit 205.

The print setting screen extension unit 205 is invoked and activated by the OS in a case where the user issues an instruction to display a print setting screen on the drawing application 201. The print setting screen extension unit 205 displays a screen on which the user can select a setting value for the printing function that is selectable based on the PC obtainable from the OS.

A control 502 in FIG. 5A is a control item by which a paper size to be used for printing can be set, and examples of items that can be set include A4 and letter.

A control 503 is a control item by which a printing orientation can be set, and portrait or landscape can be set.

A display region 504 is a region configured to display a paper type to be used for printing. A control 505 is a button by which a paper type to be used for printing can be set, and upon the user selecting the control 505, the paper type setting screen 508 in FIG. 5B is displayed. The control 505 is an example of a predetermined object.

A control 506 is a cancel button and is used to close the screen without applying the settings.

A control 507 is an OK button and is used to close the screen after applying the settings.

In the present embodiment, A4 is selected for the paper size, portrait is selected for the printing orientation, and plain paper is selected for the paper type.

In a case where the printing function and other printing functions described above are selected by the user and the OK button represented by the control 507 is pressed, the print setting screen extension unit 205 applies the selected printing functions to the PT and ends processing.

FIG. 5B illustrates the paper type setting screen 508 displayed in a case where a settings button represented by the control 505 is pressed.

A control 509 is a button for re-acquiring the paper information from the printing apparatus 102 and is used to perform a process illustrated in FIG. 3 in which the detailed paper information is added to the printing function information 203 and the paper types presented in a control 510 are updated based on the updated PDC 203. The control 509 is an example of an object configured to acquire the detailed paper information from the printing apparatus 102.

The control 510 is a control item by which a paper type to be used for printing can be selected, and displays a detailed paper information list for each paper type. In the present embodiment, the name and type of paper presented in the control 510 are defined as paper type information. Further, the paper property information (basis weight, feature, finish, color), the information about the image processing performed by the printing apparatus 102 (ink usage), and the information relating to the control performed by the printing apparatus 102 (transport unit vacuum strength) are listed and displayed as the detailed paper information in the control 510. The detailed paper information is listed and displayed in association with the paper type information for each paper type in the control 510.

The items of the paper type information and the detailed paper information are not limited to the items described in the present embodiment. Information other than the items described in the present embodiment may be included, or only some of the items may be included.

A control 511 is a cancel button and is used to close the screen without applying the settings.

A control 512 is an OK button and is used to close the screen after applying the settings.

On the paper type setting screen 508, the user may select a desired paper type by selecting the paper type information or the detailed paper information and set the paper type, register the paper type as a favorite, or change a display method or the like, which will be described in detail below. For example, the user selects a paper type from the paper type information or the detailed paper information in the control 510 and presses the OK button represented by the control 512. In this case, the print setting screen extension unit 205 applies the selected paper type to the display region 504 in FIG. 5A and returns to the print setting screen 501 in FIG. 5A.

A control 513 is a button/object for favorite registration, and in a case where the control 513 is pressed in a state where a paper type in the control 510 is selected by the user, the selected paper type is stored as favorite information in the shared information 210. The extension application 204 acquires the favorite information from the shared information 210 during activation and applies the acquired favorite information to the display region 504 when the print setting screen 501 is first displayed.

Further, since an excessive number of paper types may cause the user to make an incorrect selection when setting a paper type, an instruction may be received from the user to change a name of paper displayed in the control 510 of the paper type setting screen 508 in FIG. 5B. Further, since it may take time for the user to find the paper that the user wishes to use for printing from a large number of paper types, an instruction to hide the paper that the user does not use may be received.

Furthermore, an instruction to change a display order may be received from the user so that the user can easily select a frequently used paper type. For example, right-clicking a paper type selected by the user in the control 510 adds a menu for changing a paper name, hiding, or moving up and down an item to change the display order, as presented by a control 514 in FIG. 5C.

These functions are information displayed by the print setting screen extension unit 205 and used for the paper type setting screen 508 in FIG. 5B. Thus, in order to prevent the PDC 203 and the PT from being affected, a list specific to the extension application 204 is created in the shared information 210 and managed.

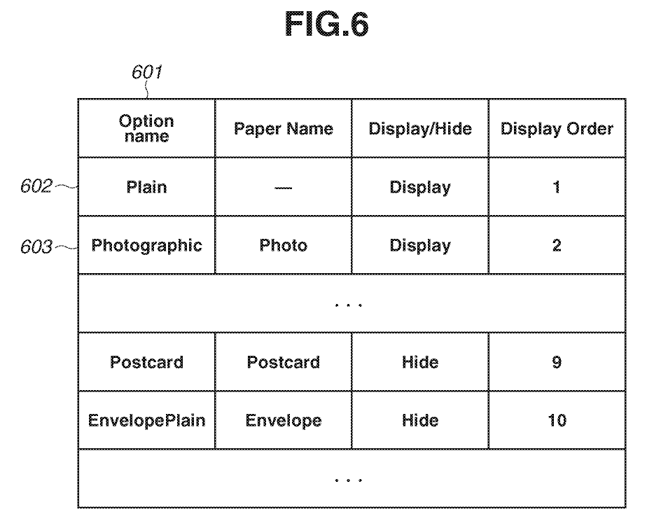

A paper information list 601 in FIG. 6 is a schematic representation of paper name information, display/hide setting information, and display order information in list form. Paper type options presented in the paper information list 601 correspond to the “PageMediaType” setting items in the capability information 401, the capability information 402, and the capability information 403. The paper information list 601 is stored in the shared information 210 and is used when the paper type setting screen 508 is displayed.

The paper information list 601 will be described in detail with reference to a row 602.

The row 602 presents the plain paper (“Option” describing “Plain” in the capability information 401 to the capability information 403) and a combination of the paper name information, the display/hide setting information, and the display order information set by the user. Specifically, the row 602 specifies that the paper name is “-” (no change), the display/hide setting is “display”, and the display order is “1”.

Similarly, a row 603 specifies that for the photographic paper (“Option” describing “Photographic”), the paper name is “Photo”, the display/hide setting is “display”, and the display order is “2”.

In a case where the user has changed the paper name, has switched the display/hide setting, or has changed the display order, the print setting screen extension unit 205 acquires the paper information list 601 from the shared information 210 and updates each item in the list. After the updates, the updated paper information list 601 is stored in the shared information 210, and the paper type setting screen 508 in FIG. 5B is displayed again based on the information in the updated paper information list 601.

Among the items of the paper information list 601, an Option name item is information for associating the capability information acquired from the printing apparatus 102 with each item of the paper information list 601 and cannot be overwritten.

As described above, using the paper information list 601 makes it possible to change the paper type information displayed in the paper type setting screen 508 in FIG. 5B without affecting the PDC 203 or the PT.

While a paper type is selected on the paper type setting screen 508 in FIG. 5B different from the print setting screen 501 in FIG. 5A to list and display the detailed paper information in the present embodiment, a paper type may be selected on the print setting screen 501. For example, a control item that makes it possible to select a paper type from a pull-down menu, such as a control 515 in FIG. 5D, is used. In this case, the detailed paper information is displayed in a tooltip upon a mouse-over, as presented by a display region 516.

Further, for example, in a case where the plain paper includes a plurality of paper types, the plurality of paper types may be grouped, and the pull-down menu may be configured to have a hierarchical layer structure, as presented by a control 517 in FIG. 5E.

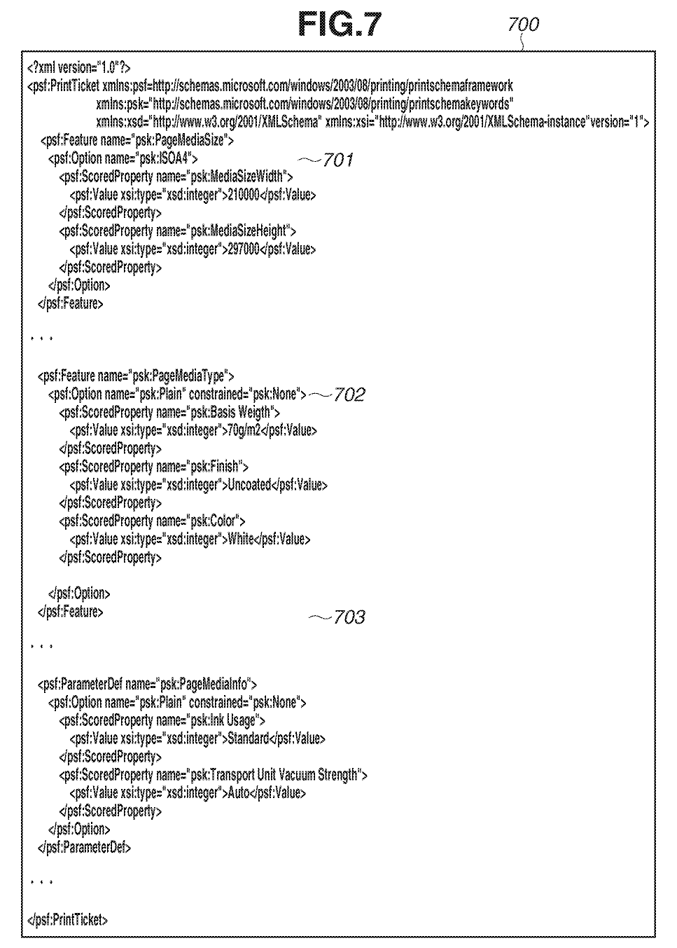

FIG. 7 illustrates an example of a PT 700 to which the paper information described above has been applied by the print setting screen extension unit 205. A function 701 includes “PageMediaSize” as a “Feature name” and “ISOA4” as the “Option name”. Specifically, this indicates that the PT 700 has been updated to a PT in a state where A4 is selected as the paper size.

Next, a function 702 includes “PageMediaType” as the “Feature name” and “Plain” as the “Option name”. Specifically, this indicates that the PT 700 has been updated to a PT in a state where plain paper is selected as the paper type.

Further, a function 703 includes “PageMediaInfo” as a “ParameterDef name” and “Plain” as the “Option name”. This indicates that since plain paper is selected as the paper type in the function 702, the PT has been updated to a state where plain paper information is selected also in the detailed paper information not defined by the OS.

As described above, in a case where the user selects A4 as the paper size and plain paper as the paper type through the print setting screen extension unit 205, the print setting screen extension unit 205 updates the PT to change the paper size to A4 and the paper type to plain paper. The PT updated by the print setting screen extension unit 205 is used thereafter.

An example has been described in which the detailed paper information is made available by the printing function extension unit 207 of the extension application 204. The method described in the present embodiment makes it possible to list and display the paper type information and the detailed paper information on a print setting screen of the extension application 204. As a result, the user can instruct the printing apparatus 102 to print after confirming the basis weight, finish, and the like set for each paper type. Further, since the ink usage and the vacuum strength of the transport unit for each paper type are also displayed, the user can instruct the printing apparatus 102 to print while paying attention to the ink consumption amount of the printing apparatus 102, the load applied to the transport unit, and the like.

### SECOND EMBODIMENT

The present disclosure is not limited to the above-described embodiment. In the first embodiment, the attribute information about vendor-specific paper information not defined by the OS among the attribute information returned by the printing apparatus 102 using the media-col-database attribute is described in the “ParameterDef” parameter.

However, instead of acquiring the vendor-specific paper information not defined by the OS from the printing apparatus 102, the vendor-specific paper information not defined by the OS may be stored in advance in the extension application 204. In this case, the detailed paper information not defined by the OS is stored for each piece of device identification information associated with the printing apparatus 102 in an installation package for the extension application 204.

In a case where the user operates the host computer 101, downloads the extension application 204 from a server via the Internet, and installs the extension application 204, the detailed paper information not defined by the OS is also stored in the host computer 101. When the printing apparatus 102 is connected to the host computer 101, the OS acquires the device identification information from the printing apparatus 102. The extension application 204 stores the detailed paper information that is not defined by the OS and is supported by the acquired device identification information in the shared information 210.

Alternatively, in a case where the printing apparatus 102 is connected to the host computer 101, the extension application 204 storing the detailed paper information that is not defined by the OS and is supported by the printing apparatus 102 may be installed automatically. Specifically, in a case where the printing apparatus 102 is connected to the host computer 101, the OS acquires the device identification information from the printing apparatus 102. The OS may download the extension application 204 supporting the acquired device identification information from the server via the Internet and install the extension application 204. In this case, the extension application 204 does not include paper information other than the paper information about the printing apparatus 102.

After the installation, the extension application 204 stores the detailed paper information that is not defined by the OS and is supported by the printing apparatus 102 in the shared information 210, as in a case where the extension application 204 is installed manually by the user.

Any system configuration not specifically described in the following description is similar to the corresponding system configuration in the first embodiment, and descriptions thereof are omitted. Further, any process not specifically described in the following description is similar to the corresponding process in the first embodiment, and descriptions thereof are omitted.

Addition of Printing Function Information to the Detailed Paper Information Not Defined by the OS by the Printing Function Extension Unit

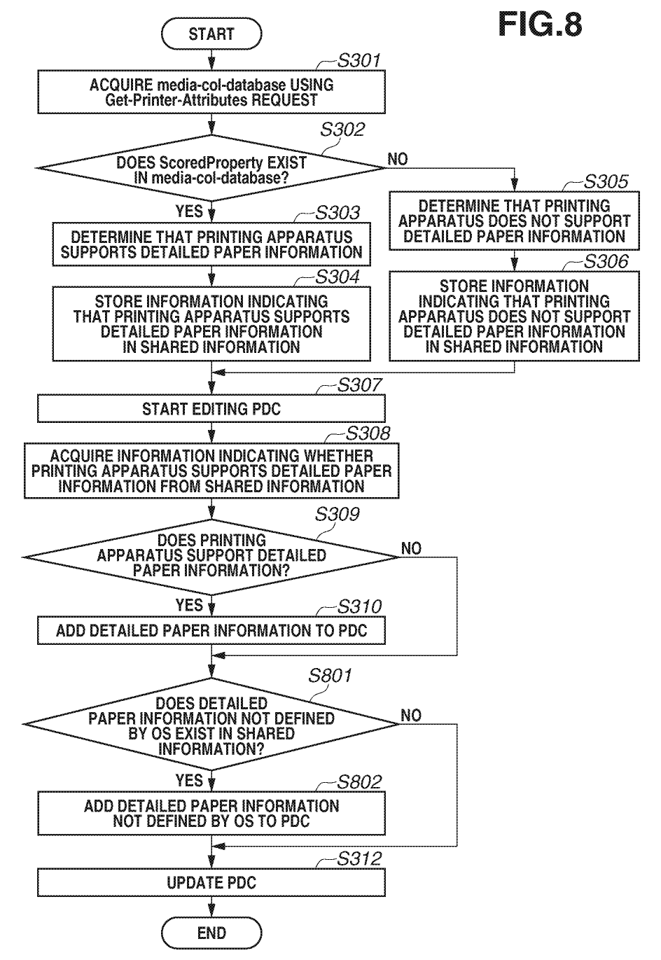

A process in which the printing function extension unit 207 of the extension application 204 adds the detailed paper information not defined by the OS to the printing function information 203 will be described with reference to FIG. 8.

Steps S301 to S306, S307 to S310, and S312 in the process illustrated in FIG. 8 are similar to those in the process illustrated in FIG. 3, so that descriptions thereof are omitted.

In step S801, the printing function extension unit 207 determines whether the detailed paper information that is not defined by the OS and is supported by the printing apparatus 102 exists in the shared information 210. In a case where the determination result is YES (YES in S801), the processing proceeds to step S802.

In step S802, the printing function extension unit 207 edits the PDC 203 acquired in step S307 and adds the detailed paper information not defined by the OS to the PDC 203, and the processing proceeds to step S312.

In step S801, in a case where the printing function extension unit 207 determines that the result is NO (NO in step S801), the processing proceeds to step S312 without adding the detailed paper information not defined by the OS to the PDC 203 in step S320.

In step S312, as in FIG. 3, the printing function extension unit 207 updates the PDC 203.

As a result of the processing by the printing function extension unit 207, the detailed paper information not defined by the OS is made available by holding the vendor-specific paper information not defined by the OS in advance in the extension application 204, instead of acquiring the vendor-specific paper information not defined by the OS from the printing apparatus 102.

Instead of including the detailed paper information not defined by the OS in the installation package for the extension application 204, the detailed paper information not defined by the OS may be held as a file in the external storage apparatus 114 of the host computer 101 or may be stored on a cloud server. In this case, when the printing apparatus 102 is connected to the host computer 101 after the extension application 204 is installed in the host computer 101, the OS acquires the device identification information from the printing apparatus 102.

The OS downloads the detailed paper information that is not defined by the OS and is supported by the acquired device identification information from the cloud server via the Internet and holds the downloaded information as a file in the external storage apparatus 114 of the host computer 101.

Further, the extension application 204 may be installed automatically in a case where the printing apparatus 102 is connected to the host computer 101. In this case, while the extension application 204 is acquired from the cloud server via the Internet, the detailed paper information that is not defined by the OS and is supported by the printing apparatus 102 is acquired from the extension application 204. Then, the acquired information is held/stored as a file in the external storage apparatus 114 of the host computer 101.

Alternatively, in step S801 in FIG. 8, the printing function extension unit 207 determines whether the detailed paper information that is not defined by the OS and is supported by the printing apparatus 102 exists in the file on the cloud server, instead of the shared information 210.

### THIRD EMBODIMENT

The present disclosure is not limited to the above-described embodiments. In the first embodiment, the attribute information about vendor-specific paper information not defined by the OS among the attribute information returned by the printing apparatus 102 using the media-col-database attribute is described in the “ParameterDef” parameter.

However, instead of acquiring the vendor-specific paper information not defined by the OS from the attribute information returned by the printing apparatus 102, the vendor-specific paper information not defined by the OS may be acquired using a vendor-specific communication protocol. In this case, a module configured to process the vendor-specific communication protocol is stored in the installation package for the extension application 204.

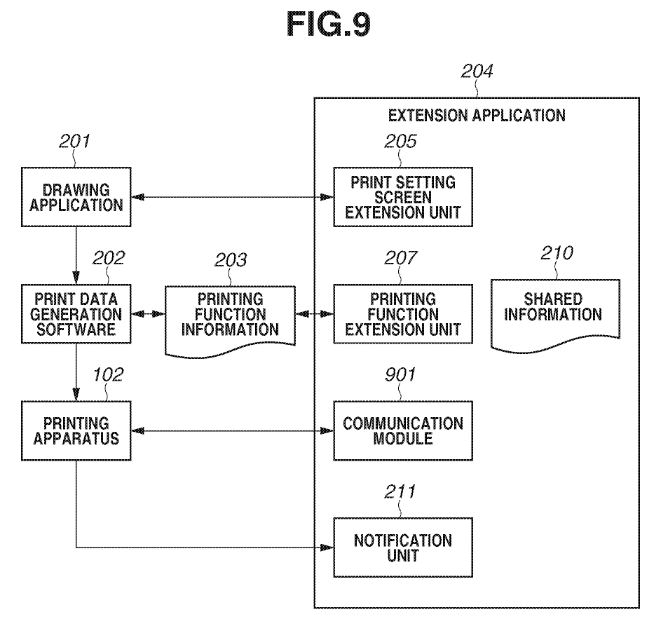

FIG. 9 is a schematic diagram illustrating a software-centric configuration of the printing system according to the present embodiment. The difference from FIG. 2B in the first embodiment is that a communication module 901 configured to process the vendor-specific communication protocol is added to the extension application 204.

While the printing function extension unit 207 of the extension application 204 acquires the attribute information from the printing apparatus 102, the extension application 204 invokes the communication module 901, acquires the detailed paper information not defined by the OS from the printing apparatus 102, and stores the acquired information in the shared information 210.

Thereafter, the printing function extension unit 207 uses the detailed paper information not defined by the OS that is stored in the shared information 210 and updates the PDC 203 as in the first embodiment.

Other configurations and processes are similar to those in FIG. 2B.

The technique according to the present disclosure makes it possible to display the detailed paper information at least including the paper type information and the paper property information even in a case where an application supporting the standard driver is used.

An embodiment of the present disclosure can also be implemented by providing, via a network or various storage media, software (a program) for executing the functions of the above-described embodiment to a system or an apparatus, and having a computer, such as a CPU or a microprocessor unit (MPU), of the system or the apparatus read and execute the program.

### OTHER EMBODIMENTS

Embodiment(s) of the present disclosure can also be realized by a computer of a system or apparatus that reads out and executes computer executable instructions (e.g., one or more programs) recorded on a storage medium (which may also be referred to more fully as a 'non-transitory computer-readable storage medium') to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)^{TM}), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2025-064132, filed Apr. 9, 2025, which is hereby incorporated by reference herein in its entirety.

What is claimed is:

1. A non-transitory computer-readable storage medium storing an application program which causes an information processing apparatus to perform a control method, the application program cooperating with a standard driver provided by a provider of an operating system of the information processing apparatus, the control method comprising:
acquiring detailed paper information at least including information indicating a property of paper used by a printing apparatus; and
displaying paper type information indicating a type of the paper and the detailed paper information.

2. The non-transitory computer-readable storage medium according to claim 1, wherein the detailed paper information further includes at least one of information relating to image processing performed by the printing apparatus and information relating to control performed by the printing apparatus.

3. The non-transitory computer-readable storage medium according to claim 1, wherein the information indicating the property includes at least one of information indicating a basis weight of the paper, information indicating a feature of the paper, information indicating a finish of the paper, and information indicating a color of the paper, information relating to image processing performed by the printing apparatus is information indicating ink usage during printing on the paper, and information relating to control performed by the printing apparatus is information indicating a vacuum strength of a transport unit of the printing apparatus during printing on the paper.

4. The non-transitory computer-readable storage medium according to claim 1, wherein the detailed paper information includes at least one of information defined by an operating system of the information processing apparatus and information not defined by the operating system.

5. The non-transitory computer-readable storage medium according to claim 1, wherein at least one of information relating to image processing performed by the printing apparatus and information relating to control performed by the printing apparatus is stored with the application program in the information processing apparatus during installation of the application program in the information processing apparatus.

6. The non-transitory computer-readable storage medium according to claim 1, wherein the detailed paper information is acquired from an external apparatus different from the printing apparatus.

7. The non-transitory computer-readable storage medium according to claim 1, wherein information not defined by the operating system is information defined by a vendor providing the printing apparatus and displayed as the detailed paper information using the application program.

8. The non-transitory computer-readable storage medium according to claim 1, wherein the information processing apparatus is further caused to display a print setting screen, and a user selects a predetermined object displayed on the print setting screen to display the paper type information and the detailed paper information.

9. The non-transitory computer-readable storage medium according to claim 8, wherein a paper type selected from the paper type information or the detailed paper information by a user is applied to the print setting screen.

10. The non-transitory computer-readable storage medium according to claim 1, wherein an object used to acquire the detailed paper information from the printing apparatus is displayed with the paper type information and the detailed paper information.

11. The non-transitory computer-readable storage medium according to claim 1, wherein an object used to register a paper type selected from the paper type information or the detailed paper information by a user as a favorite is displayed with the paper type information and the detailed paper information.

12. The non-transitory computer-readable storage medium according to claim 1, wherein an instruction to change a name of a paper type selected from the paper type information or the detailed paper information by a user is received, and the changed name is applied to the paper type information and displayed.

13. The non-transitory computer-readable storage medium according to claim 1, wherein an instruction to hide a paper type selected from the paper type information or the detailed paper information by a user is received.

14. The non-transitory computer-readable storage medium according to claim 1, wherein an instruction to change a display order of the paper type information and the detailed paper information is received from a user.

15. The non-transitory computer-readable storage medium according to claim 1, wherein printing function information is configured to include the acquired detailed paper information, and the paper type information and the detailed paper information are displayed using capability information based on the printing function information.

16. The non-transitory computer-readable storage medium according to claim 15, wherein the printing function information is Print Device Capabilities (PDC), and the capability information is PrintCapabilities (PC).

17. The non-transitory computer-readable storage medium according to claim 1, wherein the standard driver generates print data that is able to be transmitted to a plurality of printing apparatuses.

18. A control method of an information processing apparatus, wherein a standard driver and an application program are installed in the information processing apparatus, the application program cooperating with the standard driver provided by a provider of an operating system of the information processing apparatus, the control method comprising:
acquiring detailed paper information at least including information indicating a property of paper used by a printing apparatus; and
displaying paper type information indicating a type of the paper and the detailed paper information.

19. An information processing apparatus, in which a standard driver and an application program are installed, the application program cooperating with the standard driver provided by a provider of an operating system of the information processing apparatus, the information processing apparatus comprising at least one processor, the application program including instructions, which when executed by the at least one processor, cause the information processing apparatus to:
acquire detailed paper information at least including information indicating a property of paper used by a printing apparatus; and
display paper type information indicating a type of the paper and the detailed paper information.
